(19) United States
(12) Patent Application Publication
(10) Pub. No.: US 2003/0084144 A1
(43) Pub. Date: May 1, 2003

(54) Network bandwidth optimization method and system

(76) Inventor: Greg J. Lipinski, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/999,467

(22) Filed: Oct. 30, 2001

(51) Int. Cl. G06F 15/173

(52) U.S. Cl. 709/224; 709/226

(57) ABSTRACT

A network bandwidth optimization method is disclosed. The method comprises receiving a request from an application to provide to the application network service on a network. The method also comprises automatically allocating the application a channel on the network to provide network service in response to a quality of service parameter if sufficient bandwidth exists on the network.

### TECHNICAL FIELD OF THE INVENTION

The present invention relates in general to telecommunications and, more particularly, to network bandwidth optimization.

### BACKGROUND OF THE INVENTION

Many changes in inter-personal and inter-organizational communication have been enabled by developments in a variety of protocols and multimedia communications technology. For example, multimedia communication allows text, voice and video to be used alone or in combination for communication with a wide audience. Recent developments have been focused in transport and switching of traditional voice services over Internet Protocol (IP) networks. For example, some unified services such as integrated voice and data, email and web-enabled call center applications have been introduced.

Unfortunately, conventional systems and methods for processing requests by applications for network service typically suffer from disadvantages. For example, these systems usually consider personal computer (PC) network requests by any application on the PC as having the same properties. Therefore, without regard to the type of request, bandwidth sufficiency, or fragmentation, these systems typically provide immediate network access to all of the applications requesting service. These systems thus result in granting network access to applications without sufficient bandwidths for the application to properly operate. This scenario results in poor connection quality of service for a user of the PC. Moreover, this scenario reduces the bandwidth available for other applications. When these systems grant access to a large number of requests from applications, these applications must compete for bandwidth, usually resulting in fragmented bandwidths across one or more networks, and thus insufficient bandwidths for all of the requests. Additionally, these systems do not provide network access based on any priority or criticality of operation that may be desired by a user. Therefore, these systems may not be able to guarantee network access for those applications that are considered critical and, conversely, those applications that are non-critical may fragment and burden the available system bandwidth.

### SUMMARY OF THE INVENTION

One aspect of the invention is a network bandwidth optimization method. The method comprises receiving a request from an application to provide to the application network service on a network. The method also comprises automatically allocating the application a channel on the network to provide network service in response to a quality of service parameter if sufficient bandwidth exists on the network.

Another aspect of the invention is a network bandwidth optimization application that comprises a computer-readable medium and application software resident on the computer-readable medium. The application software is operable to receive a request from an application to provide the application network service on a network. The application software is also operable to automatically allocate the application a channel on the network to provide network service in response to a quality of service parameter if sufficient bandwidth exists on the network.

A further aspect of the invention is a system for optimizing network bandwidth, that comprises an appliance operable to connect to a network and a network manager resident on the appliance. The network manager is operable to receive a request from an application to provide the application network service on the network. The network manager is also operable to automatically allocate the application a channel on the network to provide network service in response to a quality of service parameter if sufficient bandwidth exists on the network.

### BRIEF DESCRIPTION OF THE DRAWINGS

FIG. 1 is a block diagram of an embodiment of a network bandwidth optimization system utilizing teachings of the present invention;

FIG. 2 is an example of a method that may be used to provide quality of service in a network bandwidth optimization system utilizing teachings of the present invention; and

FIG. 3 illustrates an example of a method that may be used to release a channel utilizing teachings of the present invention.

### DETAILED DESCRIPTION OF THE DRAWINGS

From the foregoing, it may be appreciated that a need has arisen for processing requests by applications for network service using quality of service parameters. In accordance with the present invention, a network bandwidth optimization system and method are provided that substantially eliminate or reduce disadvantages and problems of conventional systems.

An embodiment of the present invention determines the allocation of channels within one or more networks to applications that provide varying levels of quality of service (QoS). A channel is a portion of bandwidth in a network that may be allocated to a request. The number of available channels that may be allocated depend on a variety of parameters including, but not limited to, the type of network, type of requests and number of requests interested in the network. For example, an Ethernet network connected via a digital subscriber line (DSL) or cable modem and a dial-up modem may support widely varying bandwidths. The method accepts requests for network service that may be allocated based on parameters such as, but not limited to, a quality of service level, a required amount of bandwidth, queuability, and priority. In a particular embodiment, a queuability parameter determines whether an application request may be queued, and a priority parameter determines whether a request would be immediately allocated a transient channel, independent of available bandwidth, or allocated to a long-term channel if sufficient bandwidth is available. A long-term channel may be used, for example, in an audio streaming application such as Iradio, where the user of appliance 20 is listening to streamed music from one or more sources, and expects to continue to send or receive data over the network.

One embodiment of the invention enables an appliance such as an Internet appliance to simultaneously run multiple applications by coordinating network service for each application. This provides, for example, an efficient and effective dial-up networking experience to a user, without unduly long connection and re-connection attempts, and without unnecessarily monopolizing the dial-up connection. Various embodiments assure critical network access to be available, and reduce or eliminate any fragmentation or unavailability of network access to applications. For example, a number of requests may be granted access to channels within one or more networks, only after ensuring that sufficient bandwidth exists for each of the requesting applications.

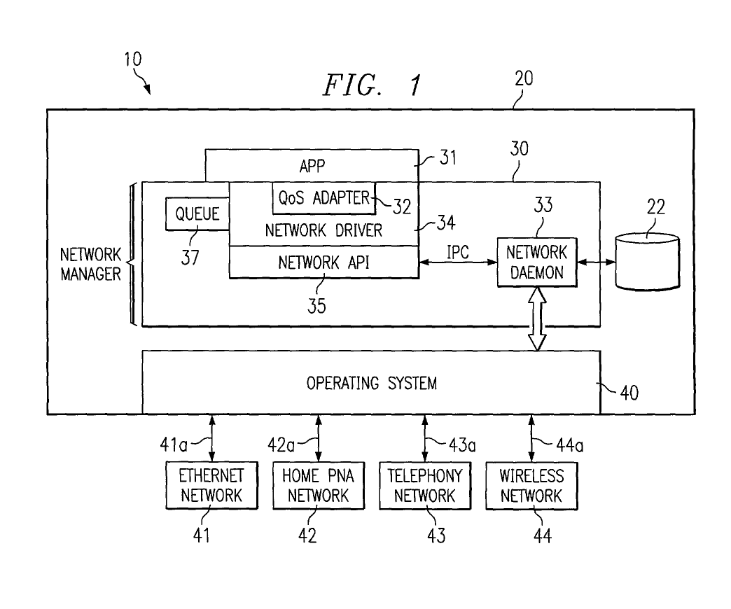

FIG. 1 is a block diagram of an embodiment of a network bandwidth optimization system utilizing teachings of the present invention. System 10 includes a computer or appliance 20 that may be used to provide network service requested by one or more applications, a process which is managed by a network manager 30. Appliance 20 is coupled to at least one of a plurality of networks 41, 42, 43, and 44 via respective communication links 41a, 42a, 43a and 44a. By example, and not by limitation, network 41 may be an Ethernet network, connected via a broadband mechanism such as a digital subscriber line (DSL) or cable modem. Network 42 may be a network that conforms with the Home Phoneline Network Alliance (HomePNA) standard, which provides use of a plurality of applications using existing wiring in a physical location such as a home residence. Network 43 may be a telephony network such as a public-switched telephone network (PSTN) that is accessible through a dialup connection (e.g., modem), and network 44 may be a wireless network. Wireless network 44 may use a protocol such as the wireless application protocol (WAP) to communicate with wireless devices such as, but not limited to, mobile phones and personal digital assistants (PDAs). Although, FIG. 1 illustrates four networks, 41-44, the present invention contemplates fewer or more networks, or communication links to networks, as desired. Computer 20 may be used to allocate channels within each of these networks that satisfy received requests.

Appliance 20 may comprise a network manager 30, at least one application 31, and an operating system (OS) 40. Appliance 20 may also include input/output (I/O) device 22. Appliance 20 may be a network appliance such as a digital entertainment center operable to process a plurality of media types, including music. Appliance 20 may also be a general or a specific purpose computer, and may be a portion of a computer adapted to execute an operating system. Appliance 20 may be a wireless device, such as a phone, personal digital assistant, or Internet appliance. Appliance 20 may access and/or include applications or software routines within network manager 30, depending on a particular application. Many methods for implementing a software architecture may be used and include, but are not limited to, object-oriented designs. I/O device 22 or other memory such as a cache or random access memory (RAM) may be suitable for storing all or a portion of these programs or routines and/or temporarily storing data during various processes performed by appliance 20. Memory and/or I/O device 22 may be used, among other things, to support real-time analysis of, storing of, and/or processing of data. In a particular embodiment, system 10 may further comprise one or more queues, such as queue 37. These queues may reside on appliance 20, a portion of I/O device 22, or a combination of both.

In a particular embodiment, network manager 30 may comprise a quality of service (QoS) adapter 32, network driver 34, network application programming interface (API) layer 35 and network daemon 33. Network driver 34 forms an interface between application 31 and network manager 30. QoS adapter 32 is operable to determine available bandwidths for each of communication links 41, 42, 43 and 44. In a particular embodiment, network driver 34 may utilize quality of service adapter 32 to determine or even generate quality of service (QoS) parameters when none are provided by an application 31. These parameters may be generated by a number of techniques that include, but are not limited to, table-lookup mechanisms, algorithmic generators and heuristic adaptation. API layer 35 forms an interface between network driver 34 and network daemon 33. These may communicate through various inter-process communications (IPC) methods, such as shared memory, message queues, and pipes. Network API 35 communicates information (e.g., network requests, application 31 bandwidth information, and/or connection/disconnect callbacks) with network daemon 33. In a particular embodiment, network API 35 may communicate with network daemon 33 using a data-and-message-transfer communication mechanism such as inter-process communications (IPC). Network manager 30 provides control mechanisms to initiate and grant network access to OS 40 to networks. Once granted, a requesting application 31, or requester 31, may use one of many known techniques that are required to directly access data through OS 40 from networks 41-44 through network interfaces (not explicitly shown).

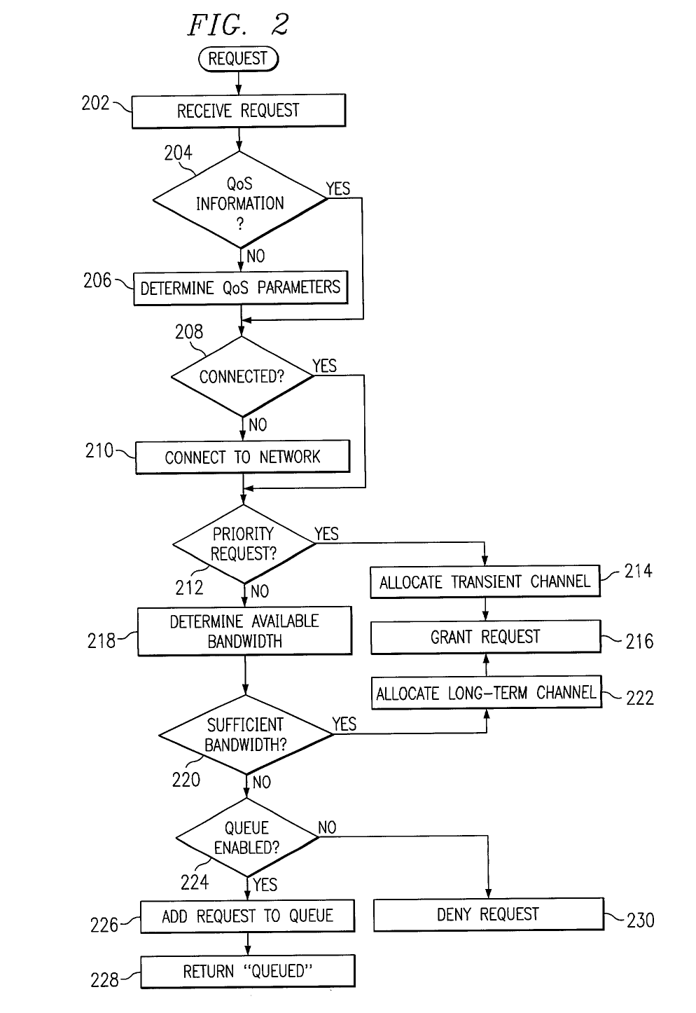

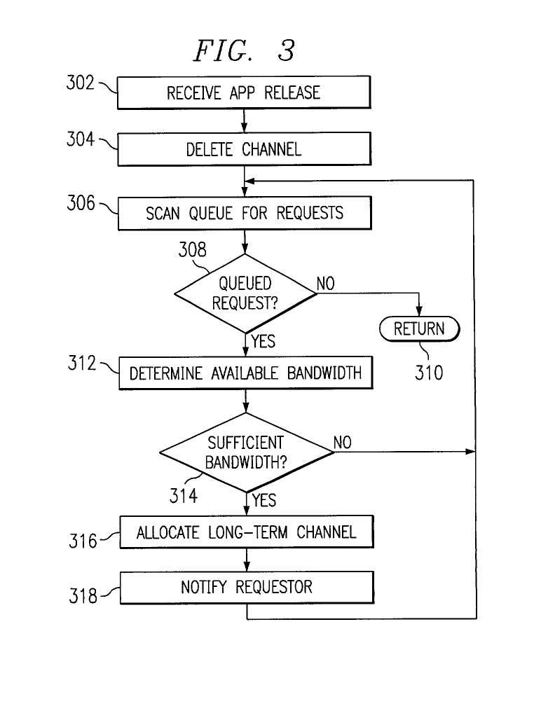

Network manager 30 preferably receives requests for network service from application(s) 31 and grants these requests using a method consistent with those discussed in further detail in conjunction with FIGS. 2 and 3. Network manager 30 will, in a particular embodiment, grant, deny, or queue a request for network service by an application 31. That is, when a request is queued, it is not granted at that time; it later is granted when sufficient bandwidth becomes available. Where the request is granted, network manager 30 will allocate a channel within the requested network. When sufficient bandwidth is not available, the network manager 30 will either deny the request, or queue the request until sufficient bandwidth becomes available, depending on the queuable parameter.

Network daemon 33 configures and controls any mechanisms in OS 40 necessary to control data transfer to network interfaces 41, 42, 43, and 44. Network daemon 33 may provide configuration and control functions by obtaining parameters such as a channel identifier, requested network, and a requester identifier from application 31. Network daemon 33 may utilize QoS parameters such as QoS level, available bandwidth, priority, and queuability to perform the functions of granting an application access and disconnecting that application when it is complete.

I/O device 22 may be any suitable storage media. Configuration files, contextual information, and other data may be stored in a variety of formats in I/O device 22. For example, contextual information may be stored in a table, flat file, or any database, including object-oriented, relational, and other databases now known or developed in the future. Contextual information may be used to tailor network service more closely to a particular application or action that might be expected by a user, and many varieties of contextual information may be used according to the teachings of the invention. Contextual information may be associated with an application, a user, a platform, a network, a connection, or all of the above. By way of example and not by limitation, contextual information for an application 31, such as an audio player requesting information over the Internet from a compact disc database (CDDB) manager, may be used to determine parameters such as, but not limited to a QoS level, a bandwidth value, priority, and queuability. For example, for a CDDB access request, QoS adapter 32 may determine that the request requires a high level of QoS, priority access, 256 Kbps bandwidth and is not queuable. For another application context such as downloading a digital music sample, QoS adapter 32 may determine that the request requires a low level of QoS, non-priority access, 56 Kbps bandwidth and is queuable. In some applications, a bandwidth value may be a desired bandwidth or a bandwidth requirement.

Although FIG. 1 illustrates a single appliance 20, the present invention encompasses the use of multiple appliances 20, so that network bandwidth optimization may be performed by any number of platforms. Each additional appliance 20 may also be similarly or identically structured to include some or all of the elements of illustrated appliance 20. In such a case, the QoS parameters for each application request would be shared with network manager 30 in each appliance. Any form of standard network communication may be used to transfer this information between appliances.

FIG. 2 illustrates an example of a method that may be used in a network bandwidth optimization system utilizing teachings of the present invention. Method 200 generally comprises the steps of receiving a request for network service from an application 31, and connecting application 31 to the requested network 41, 42, 43 or 44, depending on various parameters. In a particular embodiment, these parameters may be supplied by or associated with the requesting application, or may be determined by other methods, including heuristic methods as desired. In some applications, it may be desirable to empirically determine, or otherwise provide predetermined values for, contextual information for determining one or more parameters. This information may be stored using a variety of methods such as, but not limited to, one or more tables or in a database.

The method begins in step 202, where a request for network service is received from an application 31. In step 204, the method queries whether quality of service information is present. If so, the method proceeds to step 208. If not, in step 206, quality of service parameters are determined. In a particular embodiment, these parameters comprise a quality of service level, bandwidth required by the requesting application 31 for the request, and whether application 31 will allow the request to be queued if immediate network access is not available. Moreover, the request may include a priority parameter, in which case the method may provide immediate access to a transient channel. In a particular embodiment, these properties (parameters) may be determined by QoS adapter 32, using a variety of methods. One method for determining these properties may include the use of predetermined values for, or heuristic or other algorithms that may utilize, or even derive, these parameters from contextual or other information such as statistical information, that may be useful in assessing expected behavior of either a user or an application. By way of example and not by limitation, contextual information may be used to determine or estimate a user's tendencies for submitting certain types or patterns of requests. As another example, contextual information may be utilized to determine expected durations of such requests.

In step 208, the method queries whether a network communication link is in a connected state. For example, where system 10 is connected to a network such as Ethernet or connected to a network using a broadband connection such as a cable modem or DSL, system 10 will typically remain connected regardless of whether it is active, or whether a user is otherwise accessing any of the networks. If not, the method proceeds to step 210, where a connection to a network is made. The method queries whether the request is a priority request in step 212. If it is a priority request, in step 214, the method immediately allocates a transient channel for the application. In step 216, the request is granted. One example for a priority request is a request for CD information from a compact disc database (CDDB). Although the method contemplates the use of other criteria for allocating a transient channel, in a particular embodiment, the method automatically allocates a transient channel upon receipt of a priority request. In such an embodiment, an application may be associated with a priority request if it desires network service that results in immediate, but short-term, processing and/or access time from the network. A transient channel has a limited connection time allowed which is based on the requested bandwidth.

If the request is not a priority request in step 212, the method determines the available bandwidth in step 218. For example, the method may use network monitoring to establish the total available bandwidth, or the total bandwidth may be statically estimated based on the type of network. From such total bandwidth, regardless of how derived the bandwidth of all allocated channels may be, for example, subtracted to yield a remaining available bandwidth. The method then queries whether sufficient bandwidth exists in step 220 by comparing the remaining available bandwidth with the requested bandwidth. If so, the method allocates a long-term channel in step 222. The method preferably uses a long-term channel for servicing a request that is not a priority request. That is, in a particular embodiment, an application that desires processing and/or network service for other than immediate and short-term requests will automatically be allocated a long-term channel. A long-term channel does not time out, but is held until the application releases it. The method also contemplates allocation of a long-term channel according to other criteria in other embodiments. The method then proceeds to step 216 and grants the request. If sufficient bandwidth does not exist in response to query at step 220, the method determines whether the network request allows the request to be queued, in step 224. If so, the method adds the request to a queue such as queue 37 in step 226. The method then returns a “queued” status in step 228 to the requestor. A queued request is neither granted nor denied, but delayed until sufficient bandwidth becomes available. If, in step 224 queuing is not enabled, the method proceeds to step 230 where it denies the request. Although the method contemplates a variety of queues that may be used, in a particular embodiment, queues used are preferably prioritized first in/first out (FIFO) queues.

FIG. 3 is an example of a method that may be used to release a channel allocated in response to a request for network service by an application 31 utilizing teachings of the present invention. The method begins in step 302, where a release request is received. A release request may be, by way of example and not by limitation, a user-initiated action, such as closing a browser window, or an application-initiated action, such as a return from a JAVA script after the application has received results of its request (such as a CDDB inquiry). In step 304, the method deletes the channel previously allocated to the application. In step 306, the method scans the queue for service requests and selects a request to evaluate. If more than one service request is queued, then a service request may be selected using a number of methods. For example, the service request may be selected on a first-in-first-out (FIFO) basis, or based on a dynamically-determined priority basis. In step 308, the method queries whether a service request has been retrieved from the queue. If not, the method ends in step 310.

If a service request was retrieved from the queue in step 308, the method proceeds to step 310, where it determines the available bandwidth for the network. For example, the method may use network monitoring to establish the total available bandwidth, or the total bandwidth may be statically estimated based on the type of network. Again, from the total bandwidth of all allocated channels may be subtracted to yield a remaining available bandwidth. In step 314, the method determines whether sufficient bandwidth exists to satisfy the request. If not, the method returns to step 306 to scan the queue for other requests. If there is sufficient bandwidth in step 314, the method proceeds to step 316, where it allocates a long-term channel. In step 318, the method notifies the requestor that it is no longer queued and that it has been allocated a channel as requested. The method then returns to step 306 to scan the queue for additional requests.

The invention contemplates numerous embodiments of the method discussed in conjunction with FIGS. 2 and 3. For example, in a particular embodiment, network manager 30 may utilize a software architecture that includes one or more applications, and that may be logically composed of several classes and interfaces. These classes may operate in a distributed environment and communicate with each other using distributed communications methods, and may include a distributed component architecture. Moreover, queuing and prioritization of requests may be performed according to a number of various algorithms other than using a FIFO queue. Furthermore, embodiments of the invention may process requests using methods consistent with those discussed in FIGS. 2 and 3 simultaneously or virtually simultaneously. That is and for example, a plurality of requests may be processed while other channels allocated to other requests are being released. Moreover, various embodiments of the invention may utilize fewer or more steps, and the method may be performed using a number of different implementations and different orders of workflow, depending on the application. Some of the steps may be performed in parallel. For example, steps 306 and 312 may be processed at the same time for different requests from one or more applications 31, depending on the application. The invention also contemplates the use of various methods for many of the steps discussed. For example, a number of methods may be used to determine available bandwidth in step 218, add a request to a queue in step 226, and notify a requester in step 318.

What is claimed is:

1. A method for optimizing network bandwidth, comprising:
receiving a request from an application to provide to the application network service on a network; and
automatically allocating a channel on the network to provide the network service in response to a quality of service parameter if sufficient bandwidth exists on the network.

2. The method of claim 1, further comprising:
monitoring the network;
establishing a total available bandwidth in response to the monitoring;
determining a remaining available bandwidth in response to the total available bandwidth and bandwidths of all allocated channels on the network where a channel has been allocated; and
comparing the remaining available bandwidth with a bandwidth required by the request to determine whether sufficient bandwidth exists on the network.

3. The method of claim 1, further comprising deriving the quality of service parameter in response to contextual information.

4. The method of claim 1, further comprising deriving the quality of service parameter for the request if the request does not include a quality of service parameter.

5. The method of claim 1, wherein deriving the quality of service parameter comprises deriving one of the group consisting of a quality of service level, bandwidth value, priority, and queuability.

6. The method of claim 1, said automatically allocating the application a channel further comprising allocating the application a transient channel if the quality of service parameter comprises a high priority parameter.

7. The method of claim 1, further comprising:
monitoring a plurality of networks;
establishing a total available bandwidth for each of the plurality of networks in response to the monitoring;
determining a remaining available bandwidth, for each of the plurality of networks in response to the total available bandwidth for each of the plurality of networks, and bandwidths of all allocated channels on each of the plurality of networks where a channel has been allocated; and
comparing the remaining available bandwidth for each of the plurality of networks with a bandwidth required by the request to determine whether sufficient bandwidth exists on one of the plurality of networks.

8. A network bandwidth optimization application, comprising:
application software resident on a computer-readable medium and operable to receive a request from an application to provide to the request network service on a network; and
automatically allocate request a channel on the network to provide the network service in response to a quality of service parameter if sufficient bandwidth exists on the network.

9. The application of claim 8, further comprising the application software operable to:
monitor the network;
establish a total available bandwidth in response to the monitoring;
determine a remaining available bandwidth in response to the total available bandwidth and a bandwidth of all allocated channels on the network where a channel has been allocated; and
compare the remaining available bandwidth with a bandwidth required by the request to determine whether sufficient bandwidth exists on the network.

10. The application of claim 8, wherein the application software and the application are operatively associated with an appliance coupled to the network.

11. The application of claim 8, further comprising the application software further operable to derive the quality of service parameter in response to contextual information.

12. The application of claim 8, further comprising the application software further operable to derive the quality of service parameter for the request if the request does not include a quality of service parameter.

13. The application of claim 8, wherein the quality of service parameter comprises one of the group consisting of a quality of service level, bandwidth value, priority, and queuability.

14. The application of claim 8, wherein the channel comprises a transient channel if the quality of service parameter comprises a high priority parameter.

15. The application of claim 8, further comprising the application software operable to:
monitor a plurality of networks;
establish a total available bandwidth for each of the plurality of networks in response to the monitoring;
determine a remaining available bandwidth, for each of the plurality of networks in response to the total available bandwidth for each of the plurality of networks, and bandwidths of all allocated channels on each of the plurality of networks where a channel has been allocated; and
compare the remaining available bandwidth for each of the plurality of networks with a bandwidth required by the request to determine whether sufficient bandwidth exists on one of the plurality of networks.

16. A system for optimizing network bandwidth, comprising:
an appliance operable to connect to a network; and
a network manager resident on the appliance and operable to receive a request from an application to provide network service on the network and to automatically allocate a channel on the network to provide the network service in response to the application's quality of service parameter if sufficient bandwidth exists on the network.

17. The system of claim 16, further comprising the network manager further operable to:
monitor the network;
establish a total available bandwidth in response to the monitoring;
determine a remaining available bandwidth in response to the total available bandwidth and a bandwidth of all allocated channels on the network where a channel has been allocated; and
compare the remaining available bandwidth with a bandwidth required by the request to determine whether sufficient bandwidth exists on the network.

18. The system of claim 16, further comprising the network manager further operable to derive the quality of service parameter in response to contextual information.

19. The system of claim 16, further comprising the network manager further operable to derive the quality of service parameter for the request if the request does not include a quality of service parameter.

20. The system of claim 16, wherein the quality of service parameter comprises one of the group consisting of a quality of service level, bandwidth value, priority, and queuability.

21. The system of claim 16, wherein the channel comprises a transient channel if the quality of service parameter comprises a high priority parameter.

22. The system of claim 16, further comprising:
the appliance operable to couple to a plurality of networks; and
the network manager further operable to
monitor a plurality of networks,
establish a total available bandwidth for each of the plurality of networks in response to the monitoring,
determine a remaining available bandwidth, for each of the plurality of networks in response to the total available bandwidth for each of the plurality of networks, and bandwidths of all allocated channels on each of the plurality of networks where a channel has been allocated, and
compare the remaining available bandwidth for each of the plurality of networks with a bandwidth required by the request to determine whether sufficient bandwidth exists on one of the plurality of networks.
